(19) United States
(12) Patent Application Publication
(10) Pub. No.: US 2007/0278895 A1
(43) Pub. Date: Dec. 6, 2007

(54) Rotor of a vehicular AC generator

(75) Inventor: Shin Kusase, Oobu-shi (JP)

Correspondence Address: OLIFF & BERRIDGE, PLC, P.O. BOX 19928, ALEXANDRIA, VA, 22320, US

(73) Assignee: DENSO CORPORATION, KARIYA-CITY (JP)

(21) Appl. No.: 11/802,218

(22) Filed: May 21, 2007

(30) Foreign Application Priority Data
Jun. 6, 2006 (JP) 2006-157223

(51) Int. Cl. H02K 1/22

(52) U.S. Cl. 310/263; 310/181

(57) ABSTRACT

In a Lundell type rotor core of a rotor in a vehicular AC generator, each interposing magnet is supported at a base part of each claw-shaped magnetic pole part in an axial direction of the rotor. This configuration prevents the transmission of deformation at a front end part of each claw-shaped magnetic pole part to the interposing magnet during rotation of the rotor at high rotation speed.

### CROSS-REFERENCE TO RELATED APPLICATION

This application is related to and claims priority from Japanese Patent Application No. 2006-157223 filed on Jun. 6, 2006, the contents of which are hereby incorporated by reference.

### BACKGROUND OF THE INVENTION

1. Field of the Invention

The present invention relates to a rotor of a vehicular AC generator driven by an internal combustion engine of a vehicle, in particular, relates to an improved structure of the rotor of the vehicular AC generator.

2. Description of the Related Art

There is a demand for reducing the size of a vehicular AC generator (or an electric rotating machine for vehicles) and of increasing an output voltage thereof. In addition to such a demand, there is recently a strong demand for increasing a rotation speed of the vehicular AC generator. However, as well known by a person in this technical field, because such a vehicular AC generator has a structure of a Lundell type rotor core, there is a limit of increasing a rotation speed of the vehicular AC generator. That is, the Lundell type rotor core has a plurality of claw magnetic poles (or claw-shaped magnetic pole parts). One end of each claw-shaped magnetic pole part is supported and the other end thereof is extended in an axial direction of the Lundell type rotor core. Because a front end part of each claw-shaped magnetic pole part is deformed toward the outside in the radial direction by centrifugal force generated during a high speed rotation of the vehicular AC generator, the structure of the Lundell type rotor core limits the high speed rotation capability of the vehicular AC generator. In addition, the structure of the Lundell type rotor core requires increasing a gap between each claw-shaped magnetic pole part as a claw magnet pole and an internal surface of a stator core in the vehicular AC generator. The structure of the Lundell type rotor core further causes a drawback of easily vibrating each claw-shaped magnetic pole part with one end thereof as a fulcrum because each claw magnetic pole is supported at one end thereof.

Recently, another type of the Lundell type rotor core is adopted into a vehicular AC generator, in which a magnet is interposed between adjacent claw-shaped magnetic pole parts arranged in a circumference direction of the rotor. For example, Japanese patent laid open publication No. H07-123644 has disclosed such a related-art technique. However, such a magnet interposing mechanism causes a serious problem about the related-art drawback described above. In particular, a bending stress generated by deformation of each claw-shaped magnetic pole part is applied to the magnet interposed between the adjacent claw-shaped magnetic pole parts. Because such an interposing magnet is made of ceramic, a strong stress is applied to the magnet (or interposing magnet) interposed between the adjacent claw-shaped magnetic pole parts. In order to eliminate those related-art drawbacks described above, Japanese patent laid open publication No. JP 2001-197712 (corresponding to U.S. Pat. No. 6,333,582) has proposed a technique of improving anti-centrifugal force capability of each claw-shaped magnetic pole part, which prevents occurrence of vibration by centrifugal force, by fixing a damper ring placed on the inner surface of each claw-shaped magnetic pole part along the radial direction, which is faced to the outer surface of the rotor coil. In addition to this, the related-art technique of fixing the side surfaces in the axial direction of at least not less than two claw-shaped magnetic pole parts adjacent in the circumference direction by welding auxiliary supporting bars, auxiliary rings or fans.

There is another related-art technique disclosed in Japanese patent laid open publication No. JP 2004-135473 (corresponding to U.S. Pat. No. 7,009,324) in which a pair of interposing magnets placed both sides of one claw-shaped magnetic pole part in the circumference direction of the rotor is connected together by magnet supporting members placed so passing through an inside of the base part of the claw-shaped magnetic pole part. However, the related-art techniques JP 2001-197712 (corresponding to U.S. Pat. No. 6,333,582) and JP 2004-135473 (corresponding to U.S. Pat. No. 7,009,324) have limitation of obtaining the improved anti-centrifugal force capability. Such limitations in those related-art techniques described above will now be explained in detail.

The damper ring structure using the damper ring described above causes difficulty to fixedly connect the damper ring to each claw-shaped magnetic pole part placed at the outer side of the damper ring in the radial direction. In a typical fixing manner of fixedly connecting the damper ring to each claw-shaped magnetic pole part, the damper ring is fixed to the inner surface of each claw-shaped magnetic pole part in the radial direction of the rotor by welding. However, it is difficult to examine the condition after welding or to test reliability of the welded parts. In addition, the thermal energy generated during the welding deteriorates the magnetic characteristic of the claw-shaped magnetic pole parts of the Lundell type rotor core. Still further, the use of the damper ring decreases the accommodation amount for the rotor coil in the inside of the Lundell type rotor core in the radial direction, and further reduces the amount of cooling air which flows along an external circumference surface of the rotor coil.

Similarly, the welding of fixing the auxiliary supporting member to the side surface of each claw-shaped magnetic pole part in the axial direction requires an additional inspection step of examining the reliability of welding condition, and the thermal energy generated during welding further deteriorates the magnetic characteristic of each claw-shaped magnetic pole part.

Still further, the rotor structure described above has a drawback which requires adaptation of a magnet supporting mechanism with a large tensile strength and further introduces a complicated construction, where in such a rotor structure, a pair of the magnets placed at both sides of the claw-shaped magnetic pole part in the circumference direction of the rotor are connected by the magnet supporting member which lies through the inside of the base part of the claw-shaped magnetic pole part in the radial direction.

### SUMMARY OF THE INVENTION

It is an object of the present invention to provide a rotor of a vehicular AC generator equipped with a Lundell type rotor core of a magnet supporting mechanism capable of operating at high rotation speed.

To achieve the above purposes, the present invention provides a rotor of a vehicular AC generator equipped with a Lundell type rotor core, a plurality of interposing magnets, and a plurality of interposing magnet locking parts. The Lundell type rotor core of the rotor has a plurality of primary claw-shaped magnetic pole parts and a plurality of secondary claw-shaped magnetic pole parts which are arranged alternately in a circumference direction of the Lundell type rotor core at intervals of a predetermined pitch. Each interposing magnet is placed in a gap between the primary claw-shaped magnetic pole part and the secondary claw-shaped magnetic pole part faced to each other in the circumference direction of the rotor. The Lundell type rotor core further has a boss part inserted and fitted to a rotary shaft of the rotor, a primary pole part extending from one end of the boss part in an axial direction of the rotor toward the outside of the rotor in a radial direction, a secondary pole part extending from the other end of the boss part in the axial direction of the rotor toward the outside of the rotor in the radial direction. Each primary claw-shaped magnetic pole part projects from the primary pole part toward at least one direction in the axial direction of the rotor. Each secondary claw-shaped magnetic pole part projects from the secondary pole part toward the other direction in the axial direction of the rotor. The rotor has a rotor coil wound on the boss part and positioned at an inner side of the primary claw-shaped magnetic pole parts and the secondary claw-shaped magnetic pole parts in the radial direction of the rotor. In particular, each interposing magnet locking part is formed only in each base part of the primary and secondary claw-shaped magnetic pole parts, and capable of locking the interposing magnets. Each interposing magnet locking part transmits centrifugal force generated at the interposing magnets during the rotation of the rotor to the primary claw-shaped magnetic pole part and the secondary claw-shaped magnetic pole part adjacent to the interposing magnet in the circumference direction.

According to the present invention, the centrifugal force generated at the interposing magnet during high speed rotation of the rotor is supported by the base parts of the primary and secondary claw-shaped magnetic pole parts placed at both sides of the interposing magnet. It is possible to form the interposing magnet locking part at an intermediate part of the primary or secondary claw-shaped magnetic pole part, that is, at the area between the base end part and the front end part thereof. Even if a large magnitude of the centrifugal force is applied or generated, because the base part of the interposing magnet locking part to which a small magnitude of the centrifugal force is applied supports the centrifugal force, it is possible to prevent occurrence of a large deformation in the radial direction at the front end part of each claw-shaped magnetic pole part during the rotor operates at high rotation speed. This configuration can avoid any occurrence of various related-art problems caused by a large deformation at the front end part of each claw-shaped magnetic pole part. It is thereby possible to realize the rotor of the vehicular AC generator having a superior high-speed rotation capability with a simple configuration.

In the rotor of the vehicular AC generator as another aspect of the present invention, each interposing magnet locking part has a flange part contacted to an outer surface of the interposing magnet in the radial direction, extending toward the outside of the interposing magnet in the radial direction from the side surface of the primary claw-shaped magnetic pole part and the secondary claw-shaped magnetic pole part, and each interposing magnet has a step part projected in the radial direction from the outer surface of the interposing magnet toward the outside. The step part of the interposing magnet is contacted to the flange part formed at the base part of the primary claw-shaped magnetic pole part and the secondary claw-shaped magnetic pole part.

According to the present invention, the step part projected in the radial direction from the outer surface of the interposing magnet toward the outside is contacted to the flange part projected to the step part of the interposing magnet from the side parts of a pair of the claw-shaped magnetic pole parts adjacent to each other placed at both sides of the interposing magnet. It is thereby possible to substantially support the interposing magnet by the flange parts formed at the base parts of the claw-shaped magnetic pole parts placed at both sides of the interposing magnet in the circumference direction from the centrifugal force generated at the interposing magnet when the rotor operates at high speed rotation with a simple configuration.

In the rotor of the vehicular AC generator as another aspect of the present invention, each interposing magnet locking part has a flange part contacted to an outer surface of the interposing magnet in the radial direction, extending in the radial direction toward the outside of the interposing magnet from the side surface of the primary claw-shaped magnetic pole part and the secondary claw-shaped magnetic pole part. In particular, the flange part has a step part projecting in the radial direction from the inner surface thereof toward the inner side thereof at the base part of the primary and secondary claw-shaped magnetic pole parts contacted in the radial direction to the outer surface of the interposing magnet.

According to the present invention, because the rotor has the configuration in which the step part projected in the radial direction from the base part of each claw-shaped magnetic pole part toward the outside on the outer surface of the interposing magnet can support the centrifugal force generated at the interposing magnet, it is possible to support the centrifugal force generated at the interposing magnet by the base parts of each claw-shaped magnetic pole parts placed at both sides of the interposing magnet in the circumference direction with a simple configuration.

In the rotor of the vehicular AC generator as another aspect of the present invention, each interposing magnet locking part has a flange part and a step member. The flange part is contacted to an outer surface of the interposing magnet in the radial direction, extends toward the outside of the interposing magnet in the radial direction from the side surface of each of the primary and secondary claw-shaped magnetic pole parts. The step member is positioned at the base part of each of the primary and secondary claw-shaped magnetic pole parts and placed between the outer surface of the interposing magnet in the radial direction and the inner surface of the flange part in the radial direction.

According to the present invention, because the step member is placed between the interposing magnet and the flange part projecting in the radial direction from the base part of each claw-shaped magnetic pole part toward the outside of the interposing magnet, and the step member transmits the centrifugal force generated at the interposing magnet to the flange part, it is possible to support the centrifugal force generated at the interposing magnet by the base part of each claw-shaped magnetic pole part placed at both sides of the interposing magnet in the circumference direction with a simple configuration.

As another aspect of the present invention, there is provided a rotor in a vehicular AC generator having a Lundell type rotor core. In particular, each interposing magnet and the corresponding primary claw-shaped magnetic pole part are placed at the position where they overlap in position with the primary pole part in the axial direction of the rotor. The interposing magnet and at least a part of the primary claw-shaped magnetic pole part are placed at the outer side of the pole part extending toward the outer side in the radial direction from both sides of the boss part in the Lundell type rotor core. It is thereby possible to form the part of the inner side of the pole part in the radial direction in a disk shape, like the boss part. This configuration can efficiently support the centrifugal force generated at both of the interposing magnet and the primary claw-shaped magnetic pole part by the pole part of the primary claw-shaped magnetic pole part.

In the present invention, the secondary claw-shaped magnetic pole part has a long size in the axial direction of the rotor and has a reduced bending rigidity toward the outside thereof in the radial direction. A part of the centrifugal force generated at the interposing magnet elastically deforms the secondary claw-shaped magnetic pole part toward the outside in the radial direction. However, because the centrifugal force generated at the interposing magnet is transmitted to the pole part in the inner side of the primary claw-shaped magnetic pole part of a small elastic deformation in the radial direction toward the outside even if the rotor operates at high rotation speed, the centrifugal force generated at the interposing magnet is almost supported through the primary claw-shaped magnetic pole part when the rotor operates at high rotation speed. It is thereby possible to efficiently suppress that the centrifugal force of the interposing magnet is applied to the secondary claw-shaped magnetic pole part which is easily deformed in the radial direction toward the outside when the rotor operates at high rotation speed.

In the rotor of the vehicular AC generator as another aspect of the present invention, a base part of each secondary claw-shaped magnetic pole part having a relatively long length in the axial direction of the rotor can support the centrifugal force generated at the interposing magnet. It is thereby possible to increase the stability of the interposing magnet while efficiently suppressing the effect of the centrifugal force generated at the interposing magnet to be transmitted to the entire of the secondary claw-shaped magnetic pole part which is easily deformed toward the outside in the radial direction when the rotor operates at high rotation speed.

In the rotor of the vehicular AC generator as another aspect of the present invention, each of the primary claw-shaped magnetic pole part and the interposing magnet extends toward both sides of the primary pole part in the axial direction of the rotor. Because this configuration can increase anti-centrifugal force capability of the primary claw-shaped magnetic pole part, it is possible to efficiently support the centrifugal force generated at the interposing magnet by the primary claw-shaped magnetic pole part.

In the rotor of the vehicular AC generator as another aspect of the present invention, a claw magnetic pole supporting member has a fitting part for fitting a front end surface of the secondary claw-shaped magnetic pole part, and a fitting part for fitting a base end surface of each primary claw-shaped magnetic pole part or a front end surface of each secondary claw-shaped magnetic pole part, which are positioned at both sides of the secondary claw-shaped magnetic pole part in the circumference direction of the rotor. It is thereby possible to efficiently prevent the deformation of the front end part of the secondary claw-shaped magnetic pole part of a longer length in the axial direction, toward the outside in the radial direction by the claw magnet pole supporting member. In particular, this configuration can fix the secondary claw-shaped magnetic pole part to the claw magnet pole supporting member with a simple configuration and by a simple manufacturing manner.

In the rotor of the vehicular AC generator as another aspect of the present invention, the claw magnetic pole supporting member has the fitting part for fitting the front end surface of the secondary claw-shaped magnetic pole part, and the fitting part for fitting the base end surface of each primary claw-shaped magnetic pole part or the front end surface of each secondary claw-shaped magnetic pole part, which are positioned at both sides of the secondary claw-shaped magnetic pole part in the circumference direction of the rotor. In particular, the claw magnetic pole supporting member is made of non-magnetic material. It is thereby possible to prevent the deformation of the claw-shaped magnetic pole part toward the outside in the radial direction when the rotor operates at high rotation speed with a simple configuration and a simple manufacturing manner.

In the rotor of the vehicular AC generator as another aspect of the present invention, the claw magnetic pole supporting member has an annular plate shape inserted and fitted to the rotary shaft. In the configuration, because the claw magnetic pole supporting member has such an annular plate shape, the centrifugal force applied in the axial direction to the front end part of the claw-shaped magnetic pole part is transmitted to the rotary shaft of the rotor through the claw magnetic pole supporting member. It is thereby possible to efficiently prevent the deformation of the front end part of the claw-shaped magnetic pole part in the radial direction.

In addition, the configuration can efficiently prevent vibration force to be applied toward the circumference direction in addition to the vibration force and centrifugal force to be applied to the claw magnet pole supporting member in the radial direction.

In the rotor of the vehicular AC generator as another aspect of the present invention, the claw magnetic pole supporting member has a flange part which forms cooling-air flow and a penetrated hole through which the cooling-air flows. The penetrated hole is formed by making the flange part. It is thereby possible to realize both capabilities of flowing cooling air and of supporting the centrifugal force of the claw-shaped magnetic pole part by the claw magnet pole supporting member.

In the rotor of the vehicular AC generator as another aspect of the present invention, in particular, the claw magnetic pole supporting member is made of non-magnetic material of an annular plate shape, and fixed to the front end part of the primary and/or claw-shaped magnetic pole parts, and contacted to the end surface of the pole part of the pole core and further inserted and fitted to the boss part of the pole core or the rotary shaft of the rotor. Because the front end part of the primary or secondary claw-shaped magnetic pole part is supported by the claw magnetic pole supporting member of the annular plate shape, it is possible to efficiently suppress the deformation of the front end part of the claw-shaped magnetic pole part in the radial direction or the circumference direction with a simple configuration.

### BRIEF DESCRIPTION OF THE DRAWINGS

A preferred, non-limiting embodiment of the present invention will be described by way of example with reference to the accompanying drawings, in which:

FIG. 1 is a sectional view of a vehicular AC generator in an axial direction and show a basic configuration of the vehicular AC generator equipped with a Lundell type rotor core according to a first embodiment of the present invention;

FIG. 2 is a plan view of a development elevation of the Lundell type rotor core in the vehicular AC generator according to the first embodiment shown in FIG. 1, in particular, showing claw magnetic poles of the Lundell type rotor core elevated in a circumference direction observed from a centripetal direction;

FIG. 3 is a sectional view of a development elevation of the Lundell type rotor core in the vehicular AC generator according to the first embodiment shown in FIG. 2, in particular, showing claw magnetic poles of the Lundell type rotor core elevated in a circumference direction observed from an axial direction;

FIG. 4A is a schematic sectional view in the axial direction of the Lundell type rotor core of the vehicular AC generator according to a second embodiment of the present invention;

FIG. 4B is a schematic sectional view in the axial direction of a modification example of the Lundell type rotor core of the vehicular AC generator according to the second embodiment of the present invention shown in FIG. 4A;

FIG. 5 is a plan view of a development elevation of the Lundell type rotor core in the vehicular AC generator according to the second embodiment shown in FIG. 4, in particular, showing claw-shaped magnetic poles of the Lundell type rotor core elevated in a circumference direction observed from a centripetal direction;

FIG. 6 is a schematic sectional view in the axial direction of the Lundell type rotor core of the vehicular AC generator according to a third embodiment of the present invention;

FIG. 7 is a schematic sectional view in the axial direction of the Lundell type rotor core of the vehicular AC generator according to a fourth embodiment of the present invention;

FIG. 8 is a plan view of a development elevation of a modification example of the claw-shaped magnetic pole parts of the Lundell type rotor core shown in FIG. 2; and

FIG. 9A and FIG. 9B are sectional views showing a modification example of the claw-shaped magnetic poles of the Lundell type rotor core shown in FIG. 2.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### (Basic Construction of a Vehicular AC Generator)

Firstly, a description will be given of the explanation for a basic construction of a vehicular AC generator to which an improved rotor mechanism is applied. The rotor mechanism of the vehicular AC generator will be explained later in detail.

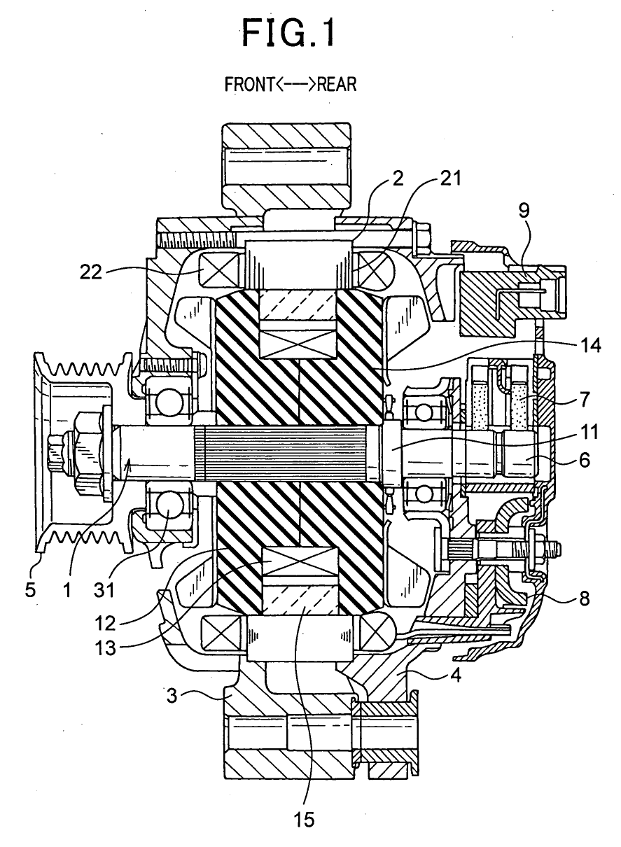

FIG. 1 is a sectional view of the vehicular AC generator in an axial direction thereof. FIG. 1 explains a basic configuration of the vehicular AC generator equipped with a Lundell type rotor core according to each embodiment of the present invention.

Reference number 1 designates a rotor, 2 denotes a stator, 3 indicates a front frame, 4 designates a rear frame, 5 denotes a pulley, 6 indicates a slip ring, 7 designates a brash mechanism, 8 denotes a rectifier, and 9 indicates a regulator. The stator 2 has a stator core 21 on which a stator coil 22 is wound. The stator 2 is fixed to the inner periphery surface of both of the front frame 3 and the rear frame 4. The front frame 3 and the rear frame 4 accommodate the stator 2 and are tightly fastened to each other by one or more through bolts. The front frame 3 and the rear frame 4 support a rotary shaft 11 of the rotor 1 through bearings 31 and 41.

The rotor 1 is composed of pole cores 12 and 14 placed at a front side and a rear side thereof, a field coil 13 (also referred to as “an exciting coil” or “a rotor coil”), and an interposing magnet 15. Both of the pole cores 12 and 14 are fixed to the rotary shaft 11.

Although FIG. 1 shows that the outer surface of the interposing magnet 15 is faced to the inner periphery surface of the stator core 21 with an infinitesimal gap separation, it is so formed that such a gap is larger than a gap between the surface of each claw-shaped magnetic pole part in the radial direction and the inner periphery surface of the stator core 21 because the outer surface of the interposing magnet 15 in the radial direction is actually a flange part.

The pole cores 12 and 14 are made by a forging manner for soft iron material in order to increase flexural strength thereof. The interposing magnet 15 is made of neodymium magnet (Nd₂Fe₁₄B), for example. It is also possible to use metal plates for protecting the interposing magnet 15. Each of the pole cores 12 and 14 is also called to as “a Lundell type rotor core”.

The pole core 12 is composed of a boss part, a primary pole part, and primary claw-shaped magnetic pole parts 124 of a predetermined number, where the boss part in the pole core 12 is inserted and fitted into the rotary shaft 11. The primary pole part extends in the radial direction from the front side part of the boss part toward the outside thereof. Each primary claw-shaped magnetic pole part 124 extends from the outer side of the primary claw-shaped magnetic pole part 124 toward the axial direction.

The primary claw-shaped magnetic pole parts 124 are arranged in a circumference direction at intervals of a predetermined pitch. The inner part of the primary pole part in the radial direction has a ring or annular-shaped plate (or a disk), and the outside part of the primary pole part projects in the radial direction toward the base part of each primary claw-shaped magnetic pole part 124 at the same position in the circumference direction.

The pole core 14 is composed of a boss part, a secondary pole part, and secondary claw-shaped magnetic pole parts 144 of a predetermined number, where the boss part in the pole core 14 is inserted and fitted into the rotary shaft 11. The secondary pole part extends in the radial direction from the front side part of the boss part in the pole core 14 toward the outside thereof. Each secondary claw-shaped magnet part extends from the outer side of the secondary pole part in the axial direction.

The secondary claw-shaped magnetic pole parts 144 are arranged in a circumference direction at predetermined pitch intervals. Each of the secondary claw-shaped magnetic pole parts 144 is placed between the adjacent primary claw-shaped magnetic pole parts. The inner part of the secondary pole part in the radial direction has a ring or annular-shaped plate (or a disk), and the outside part of the secondary pole part in the radial direction projects toward the base part of each secondary claw-shaped magnetic pole part 144 at the same position in the circumference direction.

Because the Lundell type rotor core having such a construction is well known, the more detailed explanation thereof is omitted here. Hereinafter, each claw-shaped magnetic pole part 144 will be also referred to as “a claw magnet pole” in short.

### First Embodiment

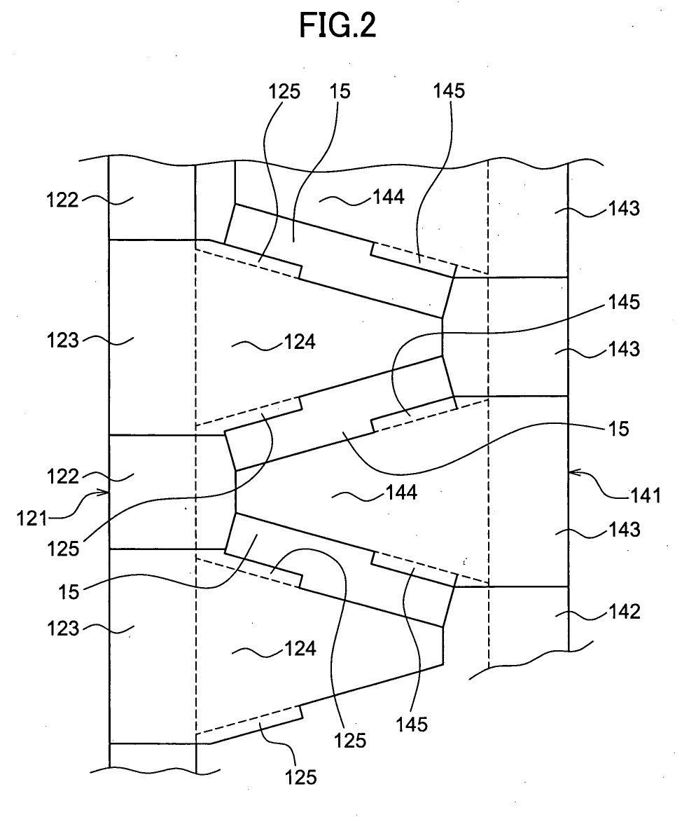

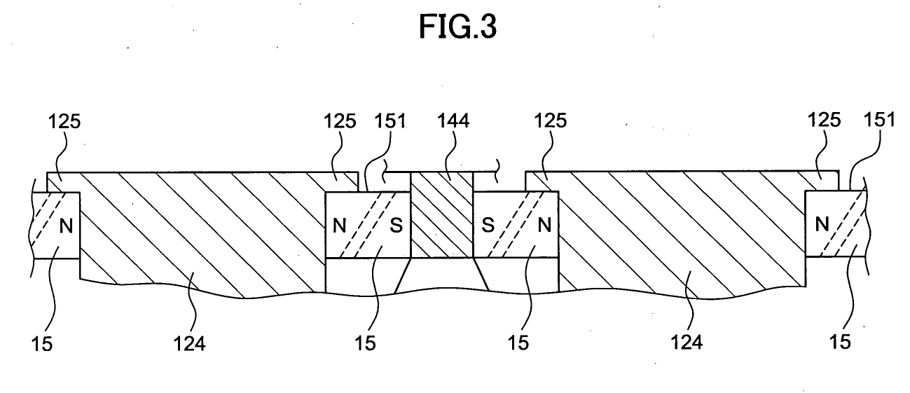

A description will now be given of the rotor of the vehicular AC generator according to the first embodiment of the present invention with reference to FIG. 2 and FIG. 3.

FIG. 2 is a plan view of a development elevation of the Lundell type rotor core in the vehicular AC generator according to the first embodiment shown in FIG. 1. In particular, FIG. 2 shows the claw-shaped magnetic pole parts of the Lundell type rotor core elevated in the circumference direction observed from a centripetal direction. FIG. 3 is a sectional view of a development elevation of the Lundell type rotor core in the vehicular AC generator according to the first embodiment shown in FIG. 2. In particular, FIG. 3 shows the claw-shaped magnetic pole parts of the Lundell type rotor core elevated in the circumference direction observed from the axial direction.

Hereinafter, a base part of each claw-shaped magnetic pole part is an area, in the axial direction of the rotor, measured from an intermediate part of the claw-shaped magnetic pole part toward the base part side side. A front part of each claw-shaped magnetic pole part is an area, in the axial direction of the rotor, from the intermediate part of the claw-shaped magnetic pole part to the front tip part. When the intermediate part is considered in addition to the base part and the front part of each claw-shaped magnetic pole part, the base part of the claw-shaped magnetic pole part is an area of approximate one-third of the total length of each claw-shaped magnetic pole part extending in the axial direction from the base part.

Reference number 121 designates a primary pole part as the pole part of the pole core 12. The primary pole part 121 is composed of a disk part 122 and a pole part 123. The disk part 122 has a larger ring plate than that of the boss part. The pole part 123 radially projects toward the outside from the outer circumference of the disk part 122.

As shown in FIG. 2, the primary claw-shaped magnetic pole part 124 projects in the axial direction towards the rear side of the rotor 1 from the pole part 123. The flange parts 125 extend from the primary claw-shaped magnetic pole part 124 toward both sides thereof along the circumferential direction at the outer circumferential side of the base part of the primary claw-shaped magnetic pole part 124. In the first embodiment, the flange parts 125 are formed at the base part side of each primary claw-shaped magnetic pole part 124.

Reference number 141 designates a secondary pole part as the pole part of the pole core 14. The secondary pole part 141 is composed of a disk part 142 and a pole part 143. The disk part 142 has a larger ring plate than that of the boss part. The pole part 143 radially projects toward the outside from the outer circumference of the disk part 142.

The secondary claw-shaped magnetic pole part 144 projects towards the front side in the axial direction of the rotor 1 from the pole part 143. The flange parts 145 extend from the secondary claw-shaped magnetic pole part 144 toward both sides thereof along the circumferential direction at the outer circumferential side of the base part of the secondary claw-shaped magnetic pole part 144. In the first embodiment, the flange parts 145 are formed at the base part side of each secondary claw-shaped magnetic pole part 144.

The interposing magnets 15 are forcedly inserted and fitted to a gap between the primary claw-shaped magnetic pole part 124 and the secondary claw-shaped magnetic pole part 144 in the circumferential direction of the rotor 1. Each interposing magnet 15 is made of neodymium magnet (Nd₂Fe₁₄B) having a rectangular shape whose sectional shape is a rectangle.

As shown in FIG. 3, the plane surface 151 (hereinafter, also referred to as “an outer surface of the interposing magnet 15 at the outside in the radial direction”) of the interposing magnet 15 in the radial direction of the rotor 1 is contacted to both of the flange part 125 of the primary claw-shaped magnetic pole part 124 and the flange part 145 of the secondary claw-shaped magnetic pole part 144.

The plane surface 151 of the interposing magnet 15 is adhered to the flange parts 125 and 14, so that the interposing magnet 15 does not escape toward the outside in the radial direction from the primary and secondary claw-shaped magnetic pole parts 124 and 144.

In general, the front part of each of the primary and secondary claw-shaped magnetic pole parts 124 and 144 is largely deformed according to the change of the rotation speed of the rotor 1. The configuration of the rotor 1 in the vehicular AC generator of the first embodiment described above can prevent the front parts of the primary and secondary claw-shaped magnetic pole parts 124, 144 and the interposing magnet 15 from breaking the connection between them because the front part of each of the primary and secondary claw-shaped magnetic pole parts 124 and 144 is not largely deformed even if the rotor 1 operates at high rotation speed.

In addition to this, the configuration of the rotor 1 described above can prevent occurrence of breaking the interposing magnet 15 by a bending stress generated when the rotor 1 operates at high rotation speed because the interposing magnet 15 is not strongly bonded or adhered to the front parts of the primary and secondary claw-shaped magnetic pole parts 124 and 144 by adhesive or bonding agent, and thereby bending stress of a large-amount is not generated at the interposing magnet 15.

On the contrary, the strong connection between the interposing magnet 15 and the primary and second claw-shaped magnet pole parts 124 and 144 introduces a drawback of generating the large amount bending stress and deformation even if the rotor 1 operates at high rotation speed. The configuration of the rotor in the vehicular AC generator according to the first embodiment of the present invention can avoid such a drawback.

According to the first embodiment, the flange part 125 and the primary claw-shaped magnet pole part 124 are integrated and formed in a single body, and the flange part 145 and the secondary claw-shaped magnet pole part 144 are also integrated and formed in a single body, and the interposing magnet 15 is supported by the flange parts 125 and 145 from the centrifugal force generated when the rotor 1 operates at high rotation speed. It is therefore possible to realize the above effects of the rotor 1 with a single configuration described above.

### Modification Example

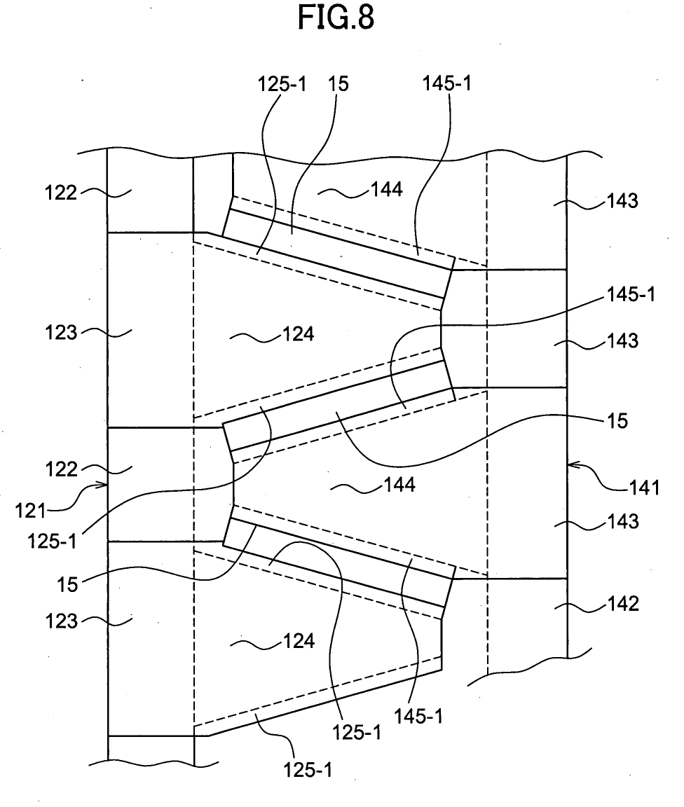

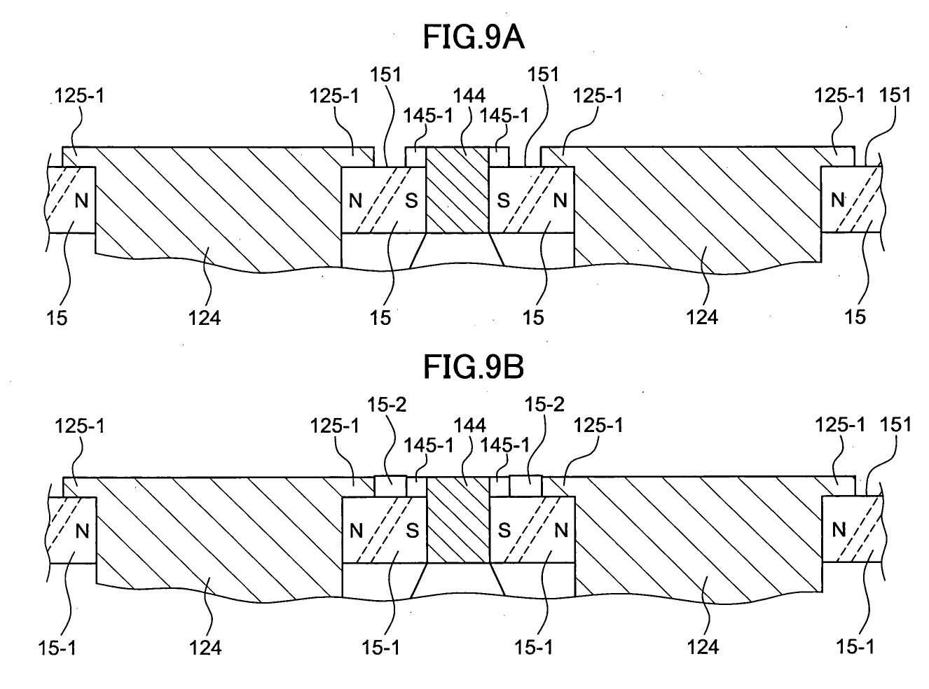

A description will now be given of a modification example of the rotor, in particular, the Lundell type rotor core of the vehicular AC generator according to the first embodiment with reference to FIG. 8, FIG. 9A and FIG. 9B.

As shown in FIG. 8, it is acceptable to form a flange part 125-1 extending from the base part toward the front part of the primary claw-shaped magnet pole part 124 instead of the flange part 125 shown in FIG. 2, and also to form the flange part 145-1 extending from the base part toward the front part of the primary claw-shaped magnet pole part 144 instead of the flange part 125 shown in FIG. 2. The interposing magnet 15 is placed between the primary claw-shaped magnet pole part 124 and the secondary claw-shaped magnet pole part 144 shown in FIG. 8.

In this configuration shown in FIG. 8, the centrifugal force generated at the interposing magnet 15 is applied only to each base part of the primary claw-shaped magnet pole part 124 and the secondary claw-shaped magnet pole part 144. Accordingly, it is acceptable to form an interposing magnet 15-1 having a step part 15-2 shown in FIG. 9B. The step part 15-2 projects in the radial direction toward the outside of the rotor 1.

Still further, it is acceptable to use a spacer instead of the step part 15-2 of the interposing magnet 15-1. The spacer is placed in the radial direction on the plane surface 151 of the interposing magnet 15 and between the flange parts 125-1 and 145-1.

### Second Embodiment

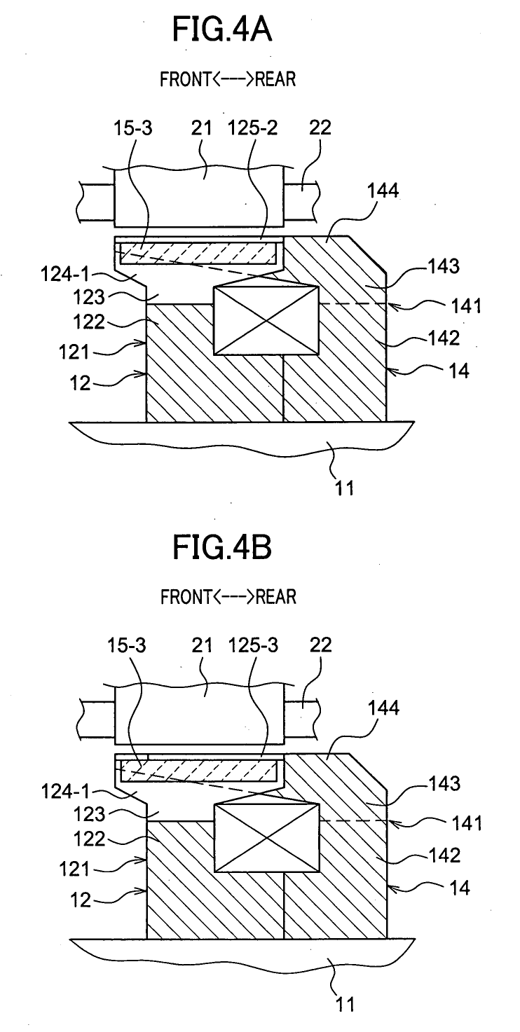

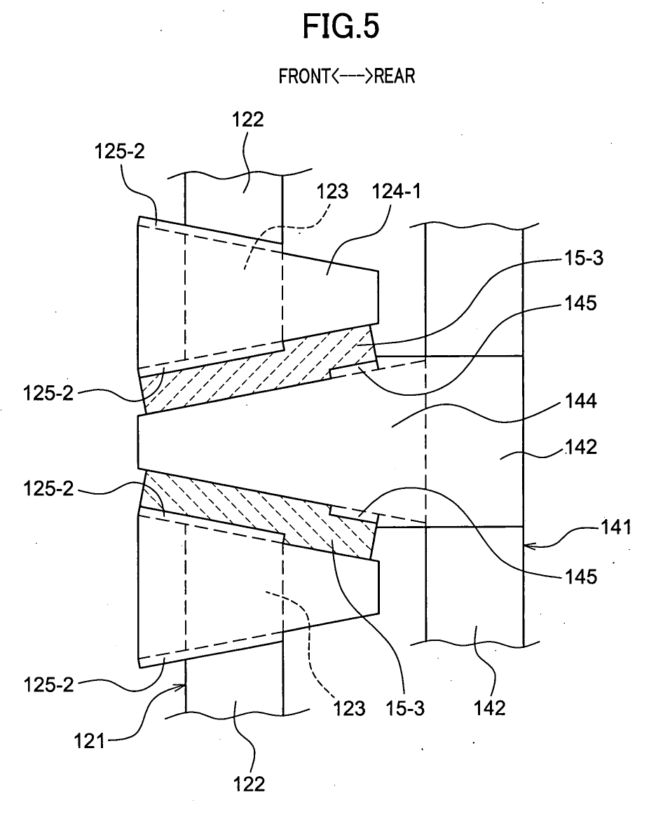

A description will now be given of the rotor of the vehicular AC generator according to the second embodiment of the present invention with reference to FIG. 4A and FIG. 5.

FIG. 4A is a schematic sectional view in the axial direction of the rotor, in particular, the Lundell type rotor core of the vehicular AC generator according to the second embodiment. FIG. 5 is a plan view of a development elevation of the Lundell type rotor core in the vehicular AC generator according to the second embodiment shown in FIG. 4A. In particular, FIG. 5 shows claw-shaped magnetic pole parts of the Lundell type rotor core elevated in a circumference direction observed from a centripetal direction.

Because the configuration of the Lundell type rotor core in the vehicular AC generator of the second embodiment is basically equal to that of the first embodiment shown in FIG. 2 and FIG. 3, the feature regarding the difference components between the second and first embodiments will now be explained, and the same components in the Lundell type rotor cores between the first and second embodiments are referred with the same numbers.

In the configuration of the Lundell type rotor core of the second embodiment shown in FIG. 4A, a primary claw-shaped magnetic pole part 124-1 projects from the pole part 123 in the primary pole part 121 toward the rear in the axial direction of the rotor 1 and further projects toward the front in the axial direction of the rotor 1. The interposing magnet 15-3 is placed so that it overlaps in position with the pole part 123 of the primary pole part 121 in the axial direction of the rotor 1, and in addition to this, the interposing magnet 15-3 more projects to both sides of the rear and front sides in the axis direction when compares with the pole part 123. The above configuration is the first feature of the second embodiment.

As shown in FIG. 5, each flange part 125-2 in the primary claw-shaped magnetic pole part 124-1 in the second embodiment is formed only at the area where the projection part of the primary claw-shaped magnetic pole part 124-1 overlaps with the pole part 123. In particular, the flange part 125-2 is not formed in the rear part of the projection part of the primary claw-shaped magnetic part 124-1. This configuration is the second feature of the second embodiment. The other configuration of the flange parts 125-2 and 145 is the same as those in the first embodiment.

It is also acceptable that the Lundell type rotor core of the vehicular AC generator of the second embodiment adopts the configuration of the flange parts 125-1 and 145-1 in the modification example of the Lundell type rotor core in the first embodiment shown in FIG. 8 and FIG. 9A.

According to the second embodiment, because the flange part 125-2 has a very small deformation when the rotor 1 of the vehicular AC generator operates at high rotation speed, it is possible to keep the connection between the flange parts 125-2 and the interposing magnets 15-3, and to prevent that a large amount of bending stress is applied to the interposing magnet 15-3.

### Modification Example

A description will now be given of a modification example of the rotor, in particular, the Lundell type rotor core of the vehicular AC generator according to the second embodiment with reference to FIG. 4B.

Instead of the configuration of the flange part 125-2 shown in FIG. 4A, it is acceptable to use a flange part 125-3 whose length in the axis direction is approximately equal to the length of the pole part 123 in the primary claw-shaped magnetic pole part 124-1.

### Third Embodiment

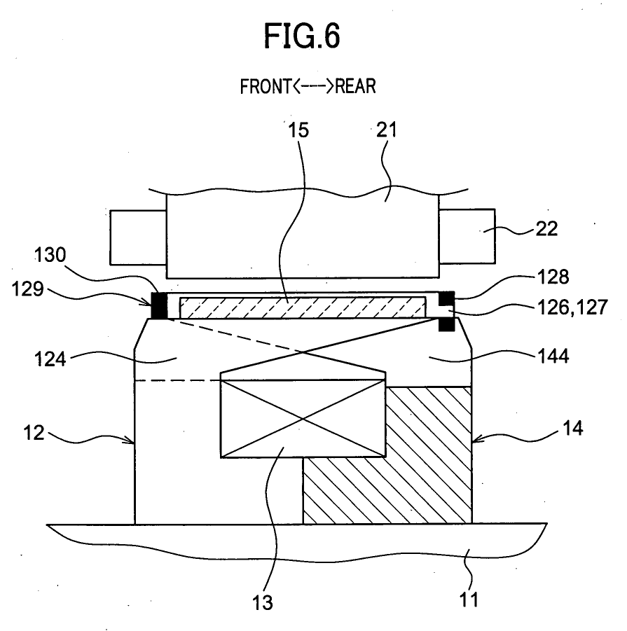

A description will now be given of the rotor of the vehicular AC generator according to the third embodiment of the present invention with reference to FIG. 6. FIG. 6 is a schematic sectional view in the axial direction of the Lundell type rotor core of the vehicular AC generator according to the third embodiment of the present invention. The configuration of the third embodiment is basically equal to that of the second embodiment shown in FIG. 4A, the feature regarding the difference components between the third and second embodiments will now be explained, and the same components in the Lundell type rotor cores between the third and second embodiments are referred with the same numbers.

In the first feature of the configuration of the Lundell type rotor core of the third embodiment shown in FIG. 6, a fitting projection part 126 is formed at the tip surface of the primary claw-shaped magnetic pole part 124. The fitting projection part 126 projects toward the rear side in the axial direction of the rotor 1. In addition to the fitting projection part 126, a primary claw magnetic pole supporting member 128 is formed in the Lundell type rotor core. The primary claw magnetic pole supporting member 128 is made of non-magnetic material and has a ring shape or an annular shape in which a penetrated hole 127 is formed. The fitting projection part 126 is inserted and fitted to the primary claw magnetic pole supporting member 128. It is preferred that the primary claw magnetic pole supporting member 128 is made of non-magnetic stainless steel and the like.

Still further, as the second feature of the configuration of the Lundell type rotor core of the third embodiment shown in FIG. 6, a fitting projection part (not shown in FIG. 6) is formed at the tip surface of the secondary claw-shaped magnetic pole part 144. This fitting projection part projects toward the rear side in the axial direction of the rotor 1. In addition to this fitting projection part, a primary claw magnetic pole supporting member 129 is also formed in the Lundell type rotor core. The secondary claw magnetic pole supporting member 129 is made of non-magnetic material and has a ring or annular shape in which a penetrated hole (not shown in FIG. 6) is formed. The corresponding fitting projection part is inserted and fitted to the secondary claw-shaped magnetic pole supporting member 129. The secondary claw magnetic pole supporting member 129 has the same shape of the primary claw magnetic pole supporting member 128. It is preferred that the primary claw magnetic pole supporting member 129 is made of non-magnetic stainless steel and the like.

The primary claw magnetic pole supporting member 128 having a ring or annular shape is contacted to the surface of the base part of the secondary claw-shaped magnetic pole part 144 at the outside in the radial direction of the rotor 1 and extends toward the circumference direction of the rotor 1. In FIG. 6, reference number 130 designates a part of the secondary claw magnetic pole supporting member 129 which is contacted to the surface of the base part of the primary claw-shaped magnetic pole part 124 at the outside in the radius direction.

In FIG. 6, the section of each of the primary and secondary claw magnetic pole supporting members 128 and 129 is black-painted with emphasis.

According to the configuration of the third embodiment described above, it is possible to efficiently suppress the deformation of the primary and secondary claw-shaped magnetic pole parts 124 and 144 toward the outside in the radial direction of the rotor 1 by the presence of the primary and secondary claw magnetic pole supporting members 128 and 129. This feature can drastically reduce the bending stress to be applied to the interposing magnet 15 when the rotor 1 operates at high rotation speed.

In the third embodiment, in particular, each of the primary and secondary claw magnetic pole supporting members 128 and 129 is inserted and fitted between the front tip parts of the primary and secondary claw-shaped magnetic pole parts 124 and 144. This configuration can prevent the change of the magnetic characteristic in the Lundell type rotor core and increase the reliability of the connection state between them when compared with the configuration where they are fixed by welding. In other words, it is possible for an unskilled worker or laborer to assemble the components of the vehicular AC generator equipped with the Lundell type rotor core of the configuration described above.

### Modification Example

In the configuration of the third embodiment shown in FIG. 6, although the front tip part of each claw-shaped magnet pole part projects in the radial direction of the rotor 1 and the penetrated hole 127 of a ring shape is formed in the claw magnetic pole supporting member, it is acceptable to form a part of a concave shape. Instead of such a configuration, it is possible that each claw magnetic pole supporting member has a projection part and the claw-shaped magnetic pole part has the concave part instead. Still further, it is possible that the claw magnetic pole supporting members 128 and 129 are inserted and fitted to the base part of each claw-shaped magnetic pole part at a position which is more inside when compared with the configuration of the third embodiment shown in FIG. 6.

### Fourth Embodiment

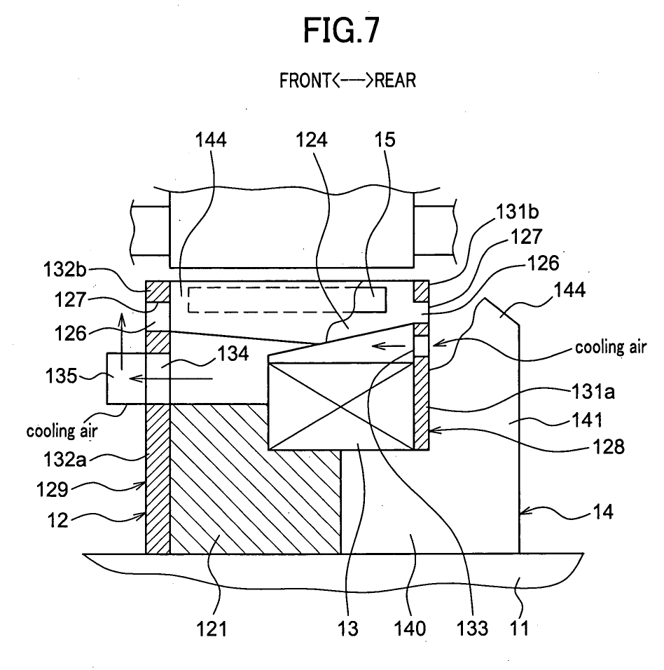

A description will now be given of the rotor of the vehicular AC generator according to the third embodiment of the present invention with reference to FIG. 7. FIG. 7 is a schematic sectional view in the axial direction of the Lundell type rotor core of the vehicular AC generator according to the fourth embodiment.

Because the configuration of the Lundell type rotor core in the vehicular AC generator according to the fourth embodiment is basically equal to that of the third embodiment shown in FIG. 6, the feature regarding the difference components between the fourth and third embodiments will now be explained, and the same components in the Lundell type rotor cores between the fourth and third embodiments are referred with the same numbers.

The first feature of the fourth embodiment is that a primary claw magnetic pole supporting member 128-1 has an annular-plate shape or a disk shape. An annular plate part 131a in the primary claw magnetic pole supporting member 128-1 having an annular-plate shape is fitted to the boss part 140 of the pole core 14 while placed between the front end surface of the secondary pole part 141 of the secondary claw-shaped magnetic pole part 144 and the rear end surface of the rotor coil 13. Still further, a fitting plate part 131b of the primary claw magnetic pole supporting member 128-1 radially projects from the outer periphery edge of the annular plate part 131 of the primary claw magnetic pole supporting member 128-1. The fitting plate part 131b has a penetrated hole 127. As has been described above, the fitting projection part 126 is inserted and fitted to the penetrated hole 127 of the fitting plate part 131b.

The second feature of the fourth embodiment is that a secondary claw magnetic pole supporting member 129-1 has an annular-plate shape or a disk shape. An annular plate part 132a in the secondary claw magnetic pole supporting member 129-1 having an annular-plate shape is fitted to the rotary shaft 11 of the rotor 1 while contacted to the front end surface of the primary pole part 121 of the primary claw-shaped magnetic pole part 124. Still further, a fitting plate part 132b radially projects from the outer periphery edge of the annular plate part 132a of the secondary claw magnetic pole supporting member 129-1. The fitting plate part 132b has a penetrated hole 127. As has been described above, the fitting projection part 126 is inserted and fitted to the penetrated hole 127 of the secondary claw-shaped magnetic pole part 144.

The third feature of the fourth embodiment is to provide a penetrated hole 133 which is formed in the annular plate part 131a in the primary claw magnetic pole supporting member 128-1. Through the penetrated hole 133, a cooling air flows in the axial direction from the rear part toward the front part of the rotor 1. While forming the penetrated hole 133 in a manufacturing process, it is acceptable to form one or more flange parts on the annular plate part 131a by cutting and rising the annular plate part 131a in order to efficiently flow the cooling air into the vehicular AC generator.

The fourth feature of the fourth embodiment is to provide a penetrated hole 134 which is formed in the annular plate part 132a in the secondary claw magnetic pole supporting member 129-1. Through the penetrated hole 134, a cooling air flows in the axial direction toward the front part of the rotor 1. While forming the penetrated hole 134 in a manufacturing process, it is acceptable to form one or more flange parts on the annular plate part 132a by cutting and rising the annular plate part 132a in order to efficiently flow the cooling air into the vehicular AC generator.

### First Modification Example

In the fourth embodiment, the primary claw magnetic pole supporting member 128-1 is fitted to the boss part 140 of the pole core 14 while placed between the front end surface of the secondary pole part 141 of the pole core 14, positioned at the rear side of the vehicular AC generator, and the rear end surface of the rotor coil 13. The fourth embodiment is not limited by this configuration. For example, when the primary claw-shaped magnetic pole part 124 extends toward the rear side in the axial direction of the rotor 1, it is possible to tightly contact the primary claw magnetic pole supporting member 128-1 to the rear end surface of the secondary pole part 141 of the pole core 14, like the case of the secondary claw magnetic pole supporting member 129-1.

### Second Modification Example

In the fourth embodiment, the secondary claw magnetic pole supporting member 129-1 is fitted to the rotary shaft 11 of the rotor 1 while contacted to the front end surface of the primary pole part 121 of the pole core 12 at the front side of the vehicular AC generator. Reducing the length of the secondary claw-shaped magnetic pole part 144 in the axial direction toward the rear side enables that the secondary claw magnetic pole supporting member 129-1 is placed between the rotor coil 13 and the rear end surface of the primary pole part 121 of the pole core 12 at the front side of the vehicular AC generator. This configuration enables that the secondary claw magnetic pole supporting member 129-1 is inserted and fitted to the boss part of the pole core 12.

### (Additional Explanation Regarding the Relationship Between Components in the Embodiments and Claims According to the Present Invention)

The flange parts 125 and 145 shown in FIG. 2 and FIG. 3 correspond to an interposing magnet locking part between magnetic poles defined in claims according to the present invention.

As has been explained in the various modification examples, it is clear that a step part can be formed on the interposing magnet 15. The step part of the interposing magnet 15 is contacted to the flange parts 125 and 145 at the base part of the primary and secondary claw-shaped magnetic pole parts, where the step part projects in the radial direction from the outer surface thereof toward the outside. When taking this configuration of the interposing magnet, the step part forms a part of the interposing magnet locking part defined in claims according to the present invention.

Further, as has been explained in the various modification examples, it is acceptable to place a spacer (a step member) in the radial direction between the outer plane surface 151 of the interposing magnet 15 and the inner surface of the flange parts 125 and 145. In this case, the spacer forms a part of the interposing magnet locking part defined in claims according to the present invention.

Still further, the fitting projection part 126 and the penetrated hole 127 correspond to a fitting part defined in claims according to the present invention.

The features of the fourth embodiment described above is that each of the claw magnet pole supporting members 128-1 and 129-1 has an annular-plate shape which is inserted and fitted to the boss part of the pole core and/or the rotary shaft of the rotor. Considering from this feature of the fourth embodiment, like related-art cases, it is possible to fix the claw magnet pole supporting members 128-1 and 129-1 to the front part of the primary claw-shaped magnetic pole part 124 and/or the secondary claw-shaped magnetic pole part 144 by welding.

### (Other Effects)

A description will now be given of other effects in addition to the effects and features of the rotor of the vehicular AC generator according to the present invention described above.

According to the present invention, the centrifugal force generated at the interposing magnet is supported by both of the claw-shaped magnetic pole parts which are placed at both sides of the interposing magnet in the circumference direction. This configuration provides a superior stability against the vibration of the claw-shaped magnetic pole parts in the circumference direction. In general, each claw-shaped magnetic pole part has a flange part extending toward the interposing magnet in the circumference direction, and the flange part is adhered to the outer surface of the interposing magnet in the radial direction by adhesive agent in order to transmit the centrifugal force. The elastic deformations at the base part and the front end part of the claw-shaped magnetic pole part in the circumference direction are different in magnitude to each other. However, the interposing magnet is generally made of ceramic material which has a large anti-deformation capability. As a result, when the rotor operates at high rotation speed, there is a possibility of separating the front end part of the claw-shaped magnetic pole part from the interposing magnet, or a large amount of bending stress occurs at the interposing magnet if a bonding force between the front end part of the claw-shaped magnetic pole part and the interposing magnet is large. The configurations disclosed in the embodiments and the modification examples of the rotor of the vehicular AC generator according to the present invention can efficiently solve such a related-art problem.

That is, according to one aspect of the present invention, the interposing magnet locking part is not formed at the front end part of the claw-shaped magnetic pole part, but formed at the base parts of a pair of the claw-shaped magnetic pole parts placed at the both sides of the interposing magnet in the circumference direction of the rotor in order to support the interposing magnet. This configuration can solve the problem that the interposing magnet is easily separated from the claw-shaped magnetic pole parts or the separation between them is easily progressed, or bending stress occurs in the interposing magnet if the claw-shaped magnetic pole parts are strongly bonded to the interposing magnet.

According to another aspect of the present invention, the centrifugal force generated in the interposing magnet is transmitted to the primary pole part in the inner side of the primary claw-shaped magnetic pole part in the radial direction. Because the primary claw-shaped magnetic pole part does not largely project in the axial direction from the primary pole part toward the outside, the front end part of the primary claw-shaped magnetic pole part has a small deformation toward the outside in the radial direction even if the rotor operates at high rotation speed. The configuration provides that the interposing magnet is not pulled toward the outside in the radial direction during the high rotation speed of the rotor, and prevents occurrence of separating the interposing magnet from the claw-shaped magnetic pole parts or occurrence of breaking the interposing magnet.

Still further, according to another aspect of the present invention, because the claw magnetic poles supporting members of non-magnetic material are provided, which are engaged with the front end part, of the claw-shaped magnetic pole part and further engaged with the claw-shaped magnetic pole parts arranged at both side thereof, the deformation of each claw-shaped magnetic pole part toward the outside in the radial direction can be efficiently reduced with high reliability when the rotor operates at high rotation speed, and prevents the deterioration of the thermal magnetic characteristic of each claw-shaped magnetic pole part. Thus, the present invention can certainly solve the related-art problems such as the deformation of the interposing magnet, the separation of the interposing magnet from the claw-shaped magnetic pole parts, and the broking of the interposing magnet to be caused by the centrifugal force when the rotor operates at high rotation speed.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A rotor in a vehicular AC generator comprising:
a Lundell type rotor core comprising a plurality of primary claw-shaped magnetic pole parts and a plurality of secondary claw-shaped magnetic pole parts which are arranged alternately in a circumference direction of the Lundell type rotor core at intervals of a predetermined pitch;
a plurality of interposing magnets, each of which being placed in a gap between the primary claw-shaped magnetic pole part and the secondary claw-shaped magnetic pole part faced to each other in the circumference direction of the rotor; and
a plurality of interposing magnet locking parts, each of which being formed only in each base part of the primary claw-shaped magnetic pole part and the secondary claw-shaped magnetic pole part, and capable of locking the interposing magnets, and each of which transmits centrifugal force generated at the interposing magnets during the rotation of the rotor to the primary claw-shaped magnetic pole part and the secondary claw-shaped magnetic pole part adjacent to the interposing magnet in the circumference direction.

2. The rotor in a vehicular AC generator according to claim 1, wherein
the Lundell type rotor core further comprises:
a boss part inserted and fitted to a rotary shaft of the rotor;
a primary pole part extending from one end of the boss part in an axial direction of the rotor toward the outside of the rotor in a radial direction;
a secondary pole part extending from the other end of the boss part in the axial direction of the rotor toward the outside of the rotor in the radial direction;
a plurality of the primary claw-shaped magnetic pole parts project from the primary pole part toward at least one direction in the axial direction of the rotor; and
a plurality of the secondary claw-shaped magnetic pole parts project from the secondary pole part toward the other direction in the axial direction of the rotor,
and the rotor further comprises a rotor coil wound on the boss part and positioned at an inner side of the primary claw-shaped magnetic pole parts and the secondary claw-shaped magnetic pole parts in the radial direction of the rotor.

3. The rotor in a vehicular AC generator according to claim 1, wherein each interposing magnet locking part comprises a flange part contacted to an outer surface of the interposing magnet in the radial direction, extending toward the outside of the interposing magnet in the radial direction from the side surface of the primary claw-shaped magnetic pole part and the secondary claw-shaped magnetic pole part, and
each interposing magnet comprises a step part projected in the radial direction from the outer surface of the interposing magnet toward the outside, and the step part of the interposing magnet is contacted to the flange parts formed at the base parts of the primary claw-shaped magnetic pole part and the secondary claw-shaped magnetic pole part.

4. The rotor in a vehicular AC generator according to claim 1, wherein each interposing magnet locking part comprises a flange part contacted to an outer surface of the interposing magnet in the radial direction, extending toward the outside of the interposing magnet in the radial direction from the side surface of the primary claw-shaped magnetic pole part and the secondary claw-shaped magnetic pole part, and
wherein the flange part has a step part projecting from the inner surface thereof toward the inner side thereof in the radial direction at the base part of the primary and secondary claw-shaped magnetic pole parts contacted to the outer surface of the interposing magnet in the radial direction.

5. The rotor in a vehicular AC generator according to claim 1, wherein each of the interposing magnet locking parts comprises:
a flange part contacted to an outer surface of the interposing magnet in the radial direction, extending in the radial direction toward the outside of the interposing magnet from the side surface of each of the primary claw-shaped magnetic pole parts and the secondary claw-shaped magnetic pole parts; and
a step member positioned at the base part of each of the primary and secondary claw-shaped magnetic pole parts and placed in the radial direction between the outer surface of the interposing magnet and the inner surface of the flange part.

6. A rotor in a vehicular AC generator comprising:
a Lundell type rotor core comprising:
a boss part inserted and fitted to a rotary shaft of the rotor;
a primary pole part extending from one end of the boss part in an axial direction of the rotor toward the outside of the rotor in a radial direction;
a secondary pole part extending from the other end of the boss part in the axial direction of the rotor toward the outside of the rotor in the radial direction;
a plurality of primary claw-shaped magnetic pole parts project from the primary pole part toward at least one direction in the axial direction of the rotor; and
a plurality of secondary claw-shaped magnetic pole parts project from the secondary pole part toward the other direction in the axial direction of the rotor, where the primary claw-shaped magnetic pole parts and the secondary claw-shaped magnetic pole parts are arranged alternately in a circumference direction of the Lundell type rotor core at intervals of a predetermined pitch,
a rotor coil wound on the boss part and positioned in the radial direction of the rotor at an inner side of the primary claw-shaped magnetic pole parts and the secondary claw-shaped magnetic pole parts;
a plurality of interposing magnets, each of which being placed in a gap between the primary claw-shaped magnetic pole part and the secondary claw-shaped magnetic pole part faced to each other in the circumference direction of the rotor; and
a plurality of interposing magnet locking parts, each of which being formed only in each base part of the primary claw-shaped magnetic pole part and the secondary claw-shaped magnetic pole part, and capable of locking the interposing magnets, and each of which transmits centrifugal force generated at the interposing magnets to the primary claw-shaped magnetic pole part and the secondary claw-shaped magnetic pole part adjacent to the interposing magnet in the circumference direction,
wherein each interposing magnet and the corresponding primary claw-shaped magnetic pole part are placed at the position where they overlap in position with the primary pole part in the axial direction of the rotor.

7. The rotor in a vehicular AC generator according to claim 6, wherein each interposing magnet transmits centrifugal force to a base part of the secondary claw-shaped magnetic pole part when the rotor rotates.

8. The rotor in a vehicular AC generator according to claim 6, wherein each of the primary claw-shaped magnetic pole part and the interposing magnet extends toward both sides of the primary pole part in the axial direction of the rotor.

9. The rotor in a vehicular AC generator according to claim 6, further comprising a claw magnetic pole supporting member comprising:
a fitting part for fitting a front end surface of the secondary claw-shaped magnetic pole part; and
a fitting part for fitting a base end surface of each primary claw-shaped magnetic pole part or a front end surface of each secondary claw-shaped magnetic pole part, which are positioned at both sides of the secondary claw-shaped magnetic pole part in the circumference direction of the rotor.

10. The rotor in a vehicular AC generator according to claim 9, wherein the claw magnetic pole supporting member is made of non-magnetic material.

11. The rotor in a vehicular AC generator according to claim 10, wherein the claw magnetic pole supporting member has an annular plate shape inserted and fitted to the rotary shaft.

12. The rotor in a vehicular AC generator according to claim 10, wherein the claw magnetic pole supporting member comprises: a flange part for forming cooling-air flow; and a penetrated hole through which the cooling-air flows.

13. A rotor in a vehicular AC generator comprising:
a Lundell type rotor core comprising:
a boss part inserted and fitted to a rotary shaft of the rotor;
a primary pole part extending from one end of the boss part of the rotor in an axial direction toward the outside of the rotor in a radial direction;
a secondary pole part extending from the other end of the boss part in the axial direction of the rotor toward the outside of the rotor in the radial direction;
a plurality of primary claw-shaped magnetic pole parts project in the axial direction of the rotor from the primary pole part toward at least one direction; and
a plurality of secondary claw-shaped magnetic pole parts project in the axial direction of the rotor from the secondary pole part toward the other direction, where the primary claw-shaped magnetic pole parts and the secondary claw-shaped magnetic pole parts are arranged alternately in a circumference direction of the Lundell type rotor core at intervals of a predetermined pitch,
a rotor coil wound on the boss part and positioned at an inner side of the primary claw-shaped magnetic pole parts and the secondary claw-shaped magnetic pole parts in the radial direction of the rotor;
a plurality of interposing magnets, each of which being placed in a gap between the primary claw-shaped magnetic pole part and the secondary claw-shaped magnetic pole part faced to each other in the circumference direction of the rotor; and
a plurality of interposing magnet locking parts, each of which being formed only in each base part of the primary claw-shaped magnetic pole part and the secondary claw-shaped magnetic pole part, and capable of locking the interposing magnets, and each of which transmits centrifugal force generated at the interposing magnets during the rotation of the rotor to the primary claw-shaped magnetic pole part and the secondary claw-shaped magnetic pole part adjacent to the interposing magnet in the circumference direction,
wherein the claw magnetic pole supporting member is made of non-magnetic material and fixed to the front end part of the primary claw-shaped magnetic pole part and/or the secondary claw-shaped magnetic pole part, and contacted to the end surface of the pole part of the pole core and further inserted and fitted to the boss part of the pole core or the rotary shaft of the rotor.
